(19) United States
(12) Patent Application Publication
(10) Pub. No.: US 2005/0153065 A1
(43) Pub. Date: Jul. 14, 2005

(54) Method to manufacture spectral pigment

(75) Inventors: William A. Lenkner, Mattoon, IL (US); William Randolph Stowell, Rising Sun, IN (US); Daniel Peter Ivkovich JR., Fairfield, OH (US); Andrew Jay Skoog, West Chester, OH (US); John Frederick Ackerman, Laramie, WY (US); John J. Campbell, West Chester, OH (US)

Correspondence Address: MCNEES WALLACE & NURICK LLC, 100 PINE STREET, P.O. BOX 1166, HARRISBURG, PA, 17108-1166, US

(73) Assignee: General Electric Company, Schenectady, NY (US)

(21) Appl. No.: 10/757,123

(22) Filed: Jan. 14, 2004

(51) Int. Cl. B05D 5/06

(52) U.S. Cl. 427/162

(57) ABSTRACT

A method for producing a coating for applying to parts used in combustive gas atmospheres includes applying a layer of a material having a high index of radiative reflectance to a surface, and then applying a layer of a material having a low index of radiative reflectance over the high reflectance layer. After sufficient alternate layers of material have been applied to meet a predetermined spectral reflectance profile, the combined layers are exposed to a heating cycle to release the combined layers from the surface. The combined layers are then collected, pulverized and mixed with the appropriate solvent for application to the desired component.

### FIELD OF THE INVENTION

The present invention relates generally to methods for preparing low emissivity coatings, and more particularly, to a method for preparing low emissivity coatings suitable for high temperature environments that may be inexpensively produced and applied.

### BACKGROUND OF THE INVENTION

The high temperature regions of turbine engines require thermal protection for metal or ceramic matrix composite parts. Often the primary heat input to a part occurs on an outer surface so that a corresponding inner surface can be air cooled to reduce the part temperature. The amount of heat, which must be removed by the cooling air, can be significantly reduced by applying a high thermal impedance, such a thermal barrier coating (TBC) to the outer surface of the part. Practically, the heat removal is limited by the available cooling air, and application of TBC allows the part to run at a lower temperature. The use of cooling air and thermal barrier coatings has been established and is currently used on selected components. A second use of cooling air is to reduce the turbulent heat transfer to a part surface by forcing a cooling air flow into the stagnant air boundary layer on the surface of combustor liners and turbine blades, for example.

In addition to TBCs and cooling air, coating systems may be used in high temperature environments where part surface temperatures reach about 2,000° F. or higher to act as radiant heat reflectors. Layers of materials having a low index of refraction for certain wavelengths of radiative energy and layers of materials having a high index of refraction, as well as high transmissivity (low loss), are alternately applied to the substrate of the part, or over the TBC layer. These alternating layers of differing refractive index respond to different wavelengths of radiant energy. When properly configured, the combined layers act to reflect certain wavelengths of radiative energy, such as that produced by a combustor, while simultaneously permitting maximum transparency for the radiation wavelengths emitted by the substrate. Stated another way, these coatings may reflect radiative energy that would act to further raise the surface temperature of the component, while simultaneously permitting radiative energy generated by the component itself to pass through the coating to further reduce the temperature of the component. U.S. Pat. No. 5,851,679, which further discloses this phenomenon, is hereby incorporated by reference.

The components, such as those produced by U.S. Pat. No. 5,851,679, are typically prepared by directly applying each of the alternating coating material layers to the component. Application techniques to apply these coats typically include evaporation and sputtering, and are performed in a deposition chamber. While these techniques are effective, they are limited to line-of-sight application, which limits the total area of coating material that can be applied, also referred to as pigment. In other words, these techniques limit the total area of coating material that can be produced in a two-dimensional deposition zone or area. Additionally, existing deposition chambers, typically cylinders having diameters of 36 inches and lengths of 40 inches, are not capable of working with larger parts, such as the combustors for larger commercial jet engines. Finally, the cost to apply the mixed coatings on parts that may fit in the deposition chamber, due to the required coatings, which must be individually applied over the previously applied coating layer, is expensive and time-consuming.

Therefore, what is needed is a method for producing the mixed coatings which is easy and inexpensive to make, and similarly easy and inexpensive to apply.

### SUMMARY OF THE INVENTION

The present invention is directed to a method for producing a coating for applying to parts used in combustive gas atmospheres. As used herein, the terms mixed coating, mixed coating layers, coatings or combined layers, dielectric coating or dielectric stack, spectral pigment or pigment each refers to the same collective coating layers that are produced by the present invention. The process includes applying at least one layer of a first material having a high index of radiative reflectance to at least one surface, and then applying at least one layer of a second material having a low index of radiative reflectance over the at least one layer of the first material such that the combined layers of first and second material meet a predetermined spectral reflectance profile. The combined layers are then exposed to a heating cycle of predetermined temperature and duration to release the combined layers from the at least one surface, and then the combined layers are collected for subsequent application to a desired part.

The present invention is further directed to a method for producing a coating for applying to parts used in combustive gas atmospheres. The process includes applying a release layer to at least one surface, and then applying at least one layer of a first material having a high index of radiative reflectance over the release layer. At least one layer of a second material having a low index of radiative reflectance is then applied over the at least one layer of the first material such that the combined layers of first and second material meet a predetermined spectral reflectance profile. The combined layers are then exposed to a heating cycle of predetermined temperature and duration to remove the release layer to release the combined layers from the at least one surface prior to collecting the combined layers.

One advantage of the method for producing the coating layers of the present invention is that it is inexpensive to make.

Another advantage of the method for producing the coating layers of the present invention is that it is inexpensive to apply to parts.

An additional advantage of the method for producing the coating layers of the present invention is that larger parts may be coated.

A further advantage of the method for producing the coating layers of the present invention is that coating layer material may be produced using existing deposition chambers.

Another advantage is that the material can readily be used for field repairs as well as new make hardware in applications where the parts in question are accessible by a paint spray apparatus.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a combustor having a liner coated according to the present invention.

FIG. 2 is a cross-sectional view of the combustor liner of FIG. 1 taken along line 2-2 having a prior art coating.

FIG. 3 is a deposition chamber having trays for increased deposition surface area for producing the coatings of the present invention.

FIG. 4 is a cross-sectional view of the combustor liner of FIG. 1 taken along line 2-2 having a coating according to the present invention.

FIG. 5 is a black body radiation curve for three different operating temperatures.

FIG. 6 is an alternate embodiment of trays for producing the coatings of the present invention.

Wherever possible, the same reference numbers will be used throughout the drawings to refer to the same or like parts.

### DETAILED DESCRIPTION OF THE INVENTION

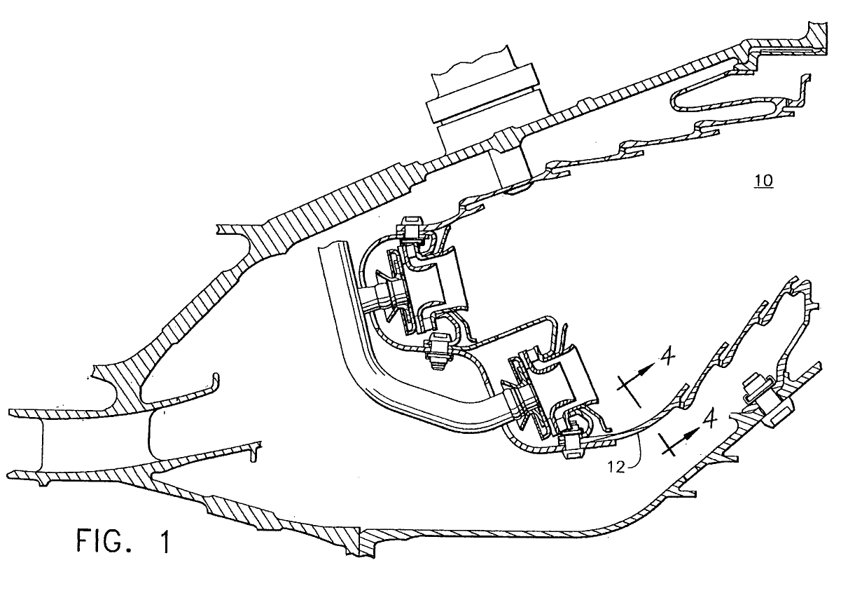

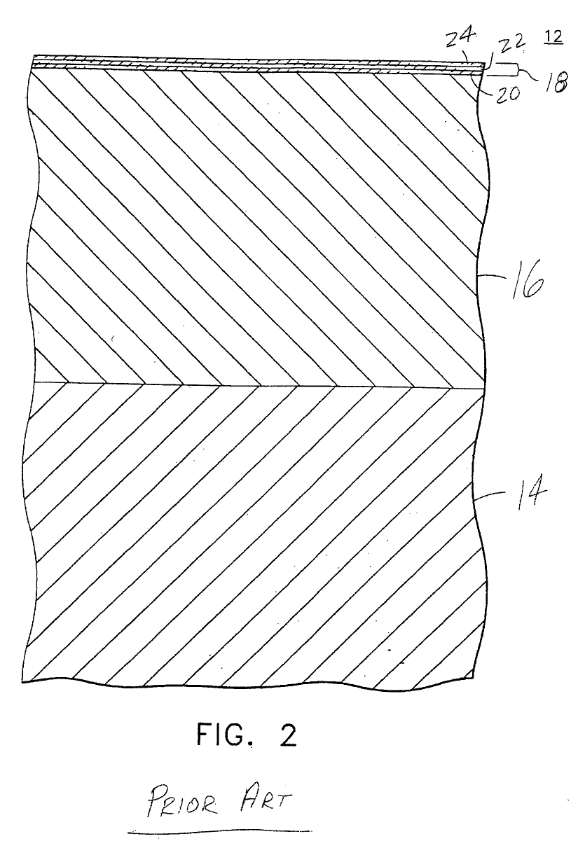

As shown in FIGS. 1 and 2, a coated article or part, such as a combustor 10, has a liner 12 having a metal or ceramic matrix composite substrate 14 and a multilayer dielectric coating 18 comprising multiple layers 20, 22, 24 wherein the multilayer coating provides a low emissivity for a radiation peak corresponding to a particular hot gas typically found in combustion atmospheres, and optionally has a thermal barrier coating 16 between the coating 18 to the substrate 14. The coated parts are preferably metal or ceramic matrix composite parts for combustion atmospheres such as nozzles, liners, turbines and combustors. The coating has low emissivity in selected wavelengths and high transmissivity in other wavelengths. In other words, the coating may have multiple layers of various materials and thicknesses thereby having low emissivity corresponding to particular radiation peaks of particular combustion gases specifically reflecting the radiation generated by the gases while permitting maximum transparency for the radiation wavelengths emitted by the substrate.

An example of materials having a high index of radiative reflectance suitable as high index layers include TiO₂, ZrO₂, Ta₂O₅, HfO₂, NbO, and Y₂O₅, and examples of materials having a low index of radiative reflectance suitable as low index layers include SiO₂, Al₂O₃, MgF₂, and BaF₂. The high index layers and low index layers preferably alternate and have desired thicknesses to provide the desired level of reflectance at the desired wavelength or wavelengths. It is believed that the present invention can reduce temperatures of the underlying structures by about 12° F. to about 180° F., depending upon the structure, although the actual temperature is dependent upon the total thermal management system that is employed. Temperature reductions in excess of 200° F. for a total thermal management system have been recorded.

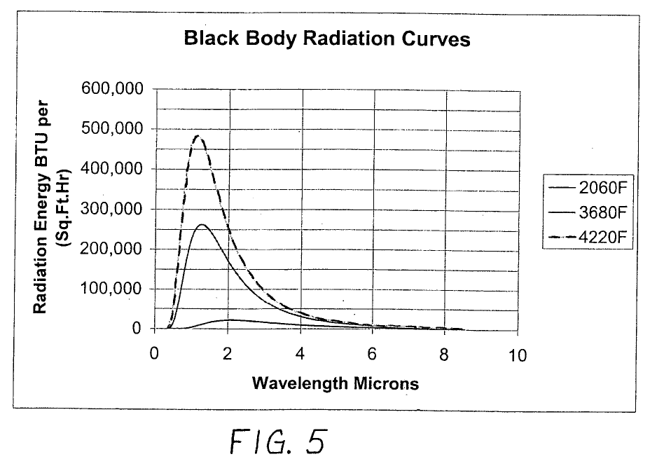

FIG. 5 illustrates the effect temperature reduction has on the amount of radiative energy absorbed by a black body. Although a perfect black body is defined as one which absorbs or gives off all incident radiation, laboratory testing produces results, including those relating to components subjected to jet engine combustion environments, closely corresponding to black bodies. For example, gas temperature in gas turbine combustors are in the range of from about 3,400° F. to more than 4,000° F., especially under maximum take-off conditions. Temperatures of 3,680° F. and 4,220° F. are provided to roughly correspond to this gas temperature range to show the high amount of radiation energy, in British Thermal Units (BTUs) per square foot per hour, that would be given off by an object for the wavelength spectrum range shown, most critically between about 0.8 microns to about 3 microns. Within this range, the amount of radiative energy released onto a component at temperatures of 3,680° F. versus 4,220° F. is nearly doubled, placing significant burdens on the thermal management system, if occurring in a jet engine. However, if it is possible to prevent the radiation from the flame from reaching the component, the heat load on the part can be reduced by amounts up to several hundred thousand BTU per square foot per hour. This reduction in thermal load reduces the cooling requirements for the part. This similarly lessens the burden on the thermal management system, and extends the service life of the components.

The present invention is directed to mass-producing the multilayer coatings while using the same deposition chambers and then applying the pulverized multilayer coating to parts in a single application by conventional methods known in the art, instead of applying multiple coatings over the part being coated after the part has been placed in a deposition chamber.

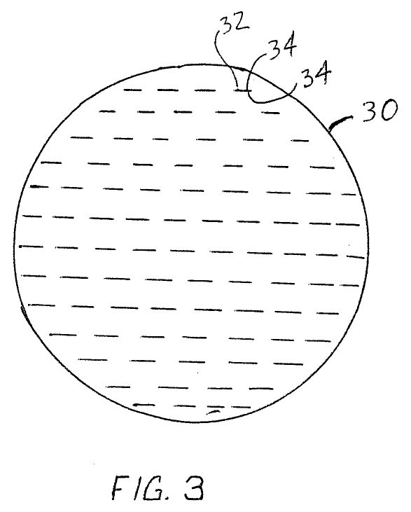

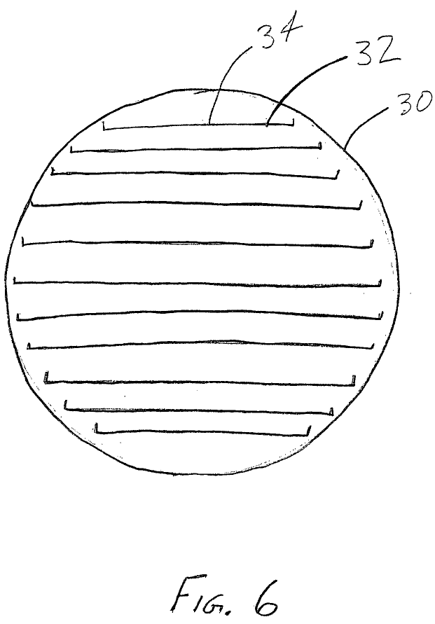

As shown in FIG. 3, a deposition chamber 30, having a diameter of about 36 inches and being about 40 inches deep as is currently available, receives a plurality of trays 32 spaced at a predetermined arrangement having respective surfaces 34. The trays 32 can be supported by any type of structure that provides substantial exposure of the tray surfaces 34 for coating. The size of trays 34 can vary widely, from small (FIG. 3) to spanning the diameter of the chamber 30 (FIG. 6). It is also possible that tray 32 can be of single piece construction, such as a spiral (not shown) or any other geometric profile, if desired, to maximize the amount of usable tray surface area. In at least one spaced arrangement, about 100,000 in² (694 ft²) of multiple coatings is produced by alternately applying high and low index layers of predetermined thickness to the surfaces 34 of trays 32. Coating techniques may include evaporation, sputtering, physical vapor deposition (PVD), chemical vapor deposition (CVD), or a combination thereof. To coat both sides of the tray 32 or part, the tray 32 or part must be manipulated or the sputtering or physical vapor deposition (PVD) source must be manipulated. The chemical vapor deposition (CVD) process is analogous to dipping parts into a “gaseous soup” in which all sides of a tray or component will be coated. As a result, the CVD process is the only process capable of applying the multiplayer reflective coating to multiple substrates, which have no line of sight view to any potential sputtering or evaporation source.

In one embodiment, prior to depositing the first high or low index layer, a glassy or diamond-like carbon layer from a source material, such as methane, ethane, propane or larger alkane molecules, or other suitable hydrocarbons, is applied to the surface 34 on both sides of the tray, such as by CVD. Once the carbon layer has been applied, a predetermined number of alternating layers of high and low index layers of predetermined thickness is preferably applied to produce the desired spectral reflectance profile. After the layers have been applied, the deposition chamber 30 subjects its contents to a heating cycle of predetermined temperature and time duration, preferably in the presence of oxygen, to burn away the initially deposited carbon layer which releases the remaining combined high and low index coating layers which are collected for subsequent use.

Alternately, in another embodiment of the present invention, the trays 32 may be comprised of a material having a thermal expansion coefficient that is sufficiently different from the thermal expansion coefficient of the coating so that the coating separates from the surface of the tray 32 during the heating cycle without requiring a carbon release layer, as described above. For example, certain stainless steels or other high temperature metals, that is, metals having a high melting point. One having skill in the art will appreciate that other release layer compositions may be used which will achieve separation of the coating from the surface 34 of tray 32, such as various types of salts or etchable metals, aluminum or gold.

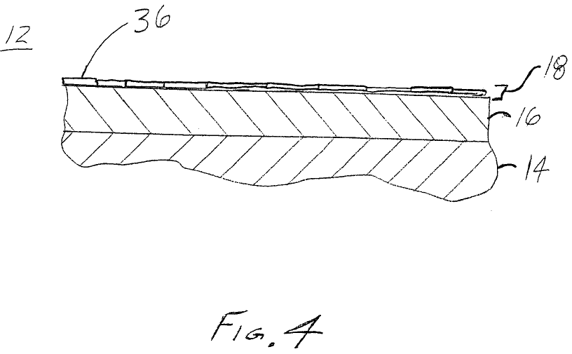

Once the heating cycle is completed and the coating has been separated from the surface 34 of the trays 32, the coating is pulverized into flakes 36 (FIG. 4). The flakes 36 are sufficiently pulverized and then mixed with the desired carrying agent for application to a substrate of a part to produce a coating having the desired spectral reflectance profile such as produced by the prior art direct application method. In other words, the coating flakes, which are comprised of the overlaid high and low index layers, may be applied by conventional methods, such as a brush or pressurized air, also referred to as spray paint. When used in a “paint system” such as a ceramic precursor slurry or ceramic tape precursor, the total system will be typically in the range of about 25 to about 100 microns. Upon drying, the flakes 36 are arranged to substantially cover the entire surface of the coated surface. FIG. 4 shows the combined layers 18 after application by the desired method, such as a single application by pressurized gas (spray paint), brush or in a tape casting system. This single application technique permits coating much larger parts than were previously possible, as this application may be performed outside of a deposition chamber. Further, the environment for such application does not require “clean room” specifications, that is, no special atmospheres are required, such as an area normally suited for conventional painting. It may also be possible to apply this coating outside under favorable conditions, such as low or absent winds, while simultaneously meeting environmental health and safety (EHS) regulations.

Although the particular application disclosed is directed to high temperature applications for providing radiant thermal loading control, such as liners, combustors, shrouds or other turbine hardware, as well as re-entry vehicles, supersonic or hypersonic vehicles. One having skill in the art can also appreciate that much lower temperature applications, such as building radiative heat reflection, is possible. Stated another way, if a proper mixture of high and low index layers are used according to the method of the present invention, it is possible, for example, to apply a coating to the outside of a brick building, or to the bricks themselves during the fabrication of the brick, to reflect radiative energy from the building, and to further permit, if applicable, the release of radiative energy from the building. Similarly, a proper coating mixture could be formulated for application to any number of applications where it is desirable to enhance radiative heat reflection away from the component while simultaneously permitting the release of radiative energy from the component. Alternately, a coating mixture could be configured to retain radiative energy received by the component as well as radiative energy released by the component, and includes applications such as furnaces, smelters. Additionally, other applications of these coatings may include reflective properties in the visual spectrum, such as decorative paints, such as for automobiles, or for improved visibility, such as highway signs or lane striping. In summary, while the potential applications are virtually limitless, the present invention provides a method to much more cost effectively produce the flakes of coating materials which may then be applied by conventional methods.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for producing a coating for applying to parts used in combustive gas atmospheres, the process comprising:
applying at least one layer of a first material having a high index of radiative reflectance to at least one surface;
applying at least one layer of a second material having a low index of radiative reflectance over the at least one layer of the first material such that the combined layers of first and second material meet a predetermined spectral reflectance profile;
exposing the combined layers to a heating cycle of predetermined temperature and duration to release the combined layers from the at least one surface; and
collecting the combined layers.

2. The method of claim 1, wherein the at least one surface has a thermal expansion coefficient sufficiently different from the thermal expansion coefficient of the combined layers to substantially release the combined layers from the at least one surface during the heating cycle.

3. The method of claim 1, wherein the step of applying the at least one layer of the first material having a high index of radiative reflectance includes applying the at least one layer of the first material having a high index of radiative reflectance selected from the group of TiO₂, ZrO₂, Ta₂O₅, HfO₂, NbO, and Y₂O₅.

4. The method of claim 1, wherein the step of applying the at least one layer of the second material having a low index of radiative reflectance includes applying the at least one layer of the second material having a low index of radiative reflectance selected from the group of SiO₂, Al₂O₃, MgF₂, and BaF₂.

5. The method of claim 1, wherein the at least one surface is a plurality of trays spaced at a predetermined arrangement.

6. The method of claim 1, wherein the plurality of trays comprises a total surface area of at least about 100,000 square inches.

7. The method of claim 1, wherein the step of applying the at least one layer of the first material having a high index of radiative reflectance to the at least one surface includes the step of applying the at least one layer of the first material selected from the group of evaporation, sputtering, physical vapor deposition or chemical vapor deposition or combination thereof.

8. The method of claim 1, wherein the step of applying the at least one layer of the second material having a low index of radiative reflectance over the at least one layer of the first material includes the step of applying the at least one layer of the second material selected from the group of evaporation, sputtering, physical vapor deposition or chemical vapor deposition or combination thereof.

9. The method of claim 1, wherein the at least one surface is comprised of compatible high temperature metals.

10. The method of claim 1, wherein the at least one surface is comprised of compatible salts.

11. The method of claim 1, wherein the at least one surface is comprised of compatible etchable metals.

12. The method of claim 11, wherein the etchable metals are aluminum and gold.

13. The method of claim 1, wherein a thickness of the combined layers collected by the step of collecting the combined layers is from about 25 microns to about 100 microns.

14. A method for producing a coating for applying to a component surface, the process comprising:
applying a release layer to at least one surface;
applying at least one layer of a first material having a high index of radiative reflectance over the release layer;
applying at least one layer of a second material having a low index of radiative reflectance over the at least one layer of the first material such that the combined layers of first and second material meet a predetermined spectral reflectance profile;
exposing the combined layers to a heating cycle of predetermined temperature and duration to remove the release layer to release the combined layers from the at least one surface; and
collecting the combined layers.

15. The method of claim 14, wherein the step of applying the at least one layer of the first material having a high index of radiative reflectance over the release layer and the step of applying the at least one layer of a second material having a low index of radiative reflectance over the at least one layer of the first material such that the combined layers of first and second material meet a predetermined spectral reflectance profile, wherein the predetermined spectral reflectance profile enhances radiative heat reflection away from the component.

16. The method of claim 15, wherein the predetermined spectral reflectance profile simultaneously permits a release of radiative energy from the component.

17. The method of claim 14, wherein the step of applying the at least one layer of the first material having a high index of radiative reflectance over the release layer and the step of applying the at least one layer of a second material having a low index of radiative reflectance over the at least one layer of the first material such that the combined layers of first and second material meet a predetermined spectral reflectance profile, wherein the predetermined spectral reflectance profile retains radiative energy received by the component.

18. The method of claim 17, wherein the predetermined spectral reflectance profile retains radiative energy released by the component.

19. The method of claim 14, wherein the step of applying the at least one layer of the first material having a high index of radiative reflectance over the release layer and the step of applying the at least one layer of a second material having a low index of radiative reflectance over the at least one layer of the first material such that the combined layers of first and second material meet a predetermined spectral reflectance profile, wherein the predetermined spectral reflectance profile has reflective properties in the visible spectrum.

20. The method of claim 19, wherein the predetermined spectral reflectance profile having reflective properties in the visible spectrum for use as a decorative paint.

21. The method of claim 19, wherein the predetermined spectral reflectance profile having reflective properties in the visible spectrum for use as a paint providing improved visibility.
